(19) United States
(12) Patent Application Publication
(10) Pub. No.: US 2007/0216346 A1
(43) Pub. Date: Sep. 20, 2007

(54) Battery charger

(75) Inventor: Sheng-Fu Lu, (US)

Correspondence Address: TROXELL LAW OFFICE PLLC, Suite 1404, 5205 Leesburg Pike, Falls Church, VA, 22041, US

(73) Assignee: Chi Sam Electronic Enterprise Co., Ltd.

(21) Appl. No.: 11/366,592

(22) Filed: Mar. 3, 2006

(51) Int. Cl. H02J 7/00

(52) U.S. Cl. 320/101

(57) ABSTRACT

A battery charger comprises a charging base having an output jacket, an input jacket, and a plurality of battery slots; and a solar panel attached to the charging base above the battery slots via a cover, wherein a pivotal rotation device is connectedly mounted between the solar panel and the cover such that the solar panel is liftable and foldable to various angles. Therefore, the rechargeable batteries can be charged by the indoor commercial electric power or the outdoor solar power for achieving the purposes of saving energy resources and providing the convenience to outdoor use. Meanwhile, the secondary environmental pollution can be avoided for fulfilling the requirement of environmental protection and bringing the best economic benefits.

### FIELD OF THE INVENTION

The present invention relates to a dual-purpose battery charger, and more particularly to a battery charger having a liftable solar panel for charging the rechargeable batteries by using the solar power or a power supply, whereby this battery charger is suitable for indoor and outdoor use.

### BACKGROUND OF THE INVENTION

With the increase of portable electronic products, the utility rate of the battery is increased significantly. After exhaustion of electric power, the commercial electric power or the car power from the car cigar-lighter is adopted as a main power source for charging the rechargeable batteries.

However, the commercial electric power has a definite specification. Therefore, an adapter or a specific transformer must be utilized if a plug is not compatible with a socket in specification or the supplied voltage is not compatible. Obviously, it is very inconvenient for the user who must travel in different countries. Besides, the car power is only suitable for car driving so the conventional charger is not an all-in-one power supply.

### SUMMARY OF THE INVENTION

It is a main object of the present invention to provide a battery charger with a solar panel, wherein this solar panel is attached to the battery charger and can be lifted up or folded down to various angles to avoid the inconvenience to carry an external solar panel and to help the receiving of solar light.

It is another object of the present invention to provide a battery charger having an attached solar panel, wherein the rechargeable batteries located in the battery slots (charging slots) can be charged via a power supply or the solar panel. Besides, the charged rechargeable batteries can be further moved to the other battery slots (power supply slots) for outputting the electric power from the rechargeable batteries.

It is still another object of the present invention to provide a portable battery charger that reduces the consumption of energy resources and avoids the secondary environmental pollution for fulfilling the requirement of environmental protection and bringing the best economic benefits.

### BRIEF DESCRIPTION OF THE DRAWINGS

FIG. 1 is a three-dimensional view of the present invention.

FIG. 2 is a three-dimensional, exploded view of the internal structure of the present invention.

FIG. 3 is a schematic view showing the usage status of the battery slots of the present invention.

FIG. 4 is a schematic assembled view of the charging base and the solar panel of the present invention.

FIG. 5 is a schematic view of the lifted solar panel of the present invention.

FIG. 6 is a schematic view of the preferred embodiment of the present invention.

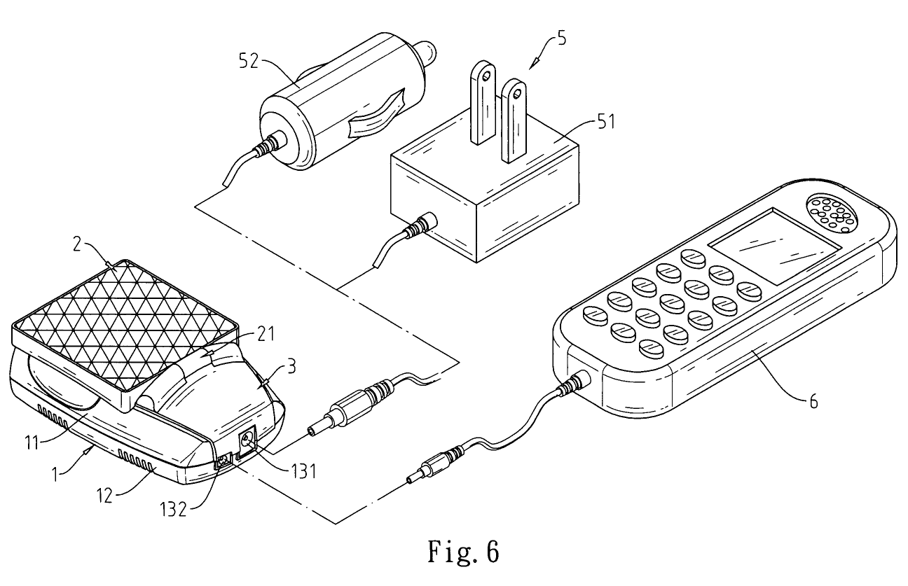

FIG. 7 is a block diagram showing the booster circuit of the present invention.

### DETAILED DESCRIPTION OF THE PREFERRED EMBODIMENT

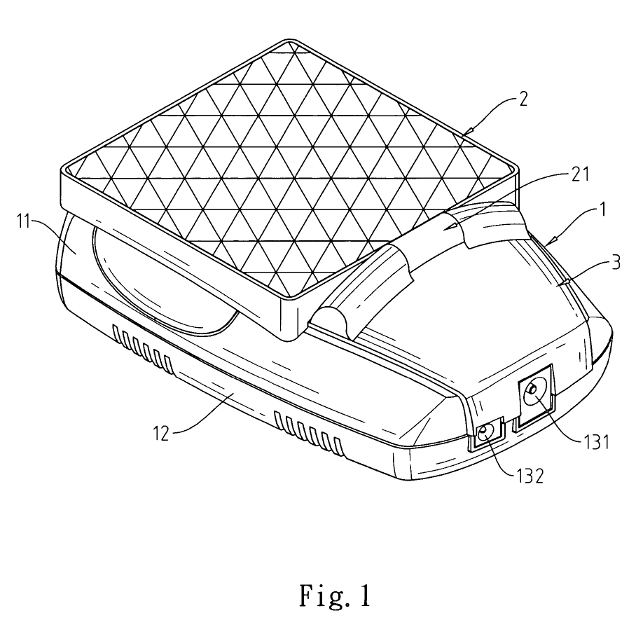

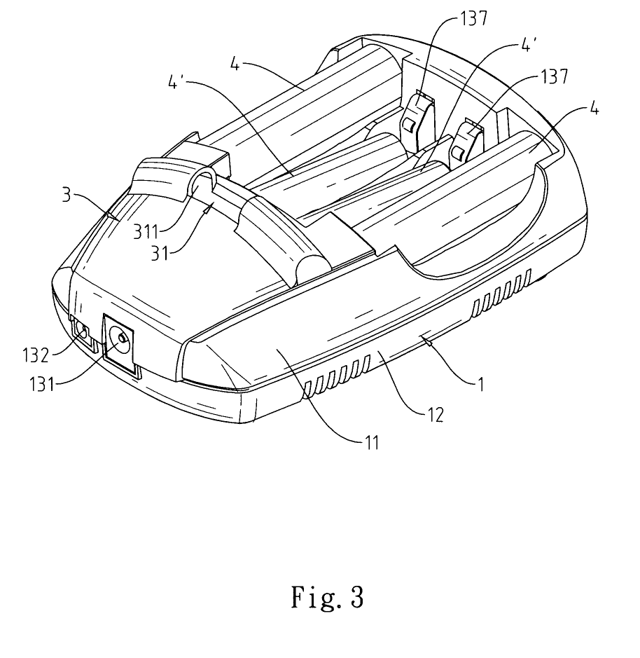

Referring to FIG. 1 and FIG. 3, as shown in FIG. 1, a battery charger having an attached solar panel is composed of a charging base 1 and a solar panel 2, wherein the solar panel 2 is designed for supplying the charging base 1 with the required electric power by transforming the solar power into the electric power, thereby achieving the purposes of saving energy resources and providing the convenience for outdoor use.

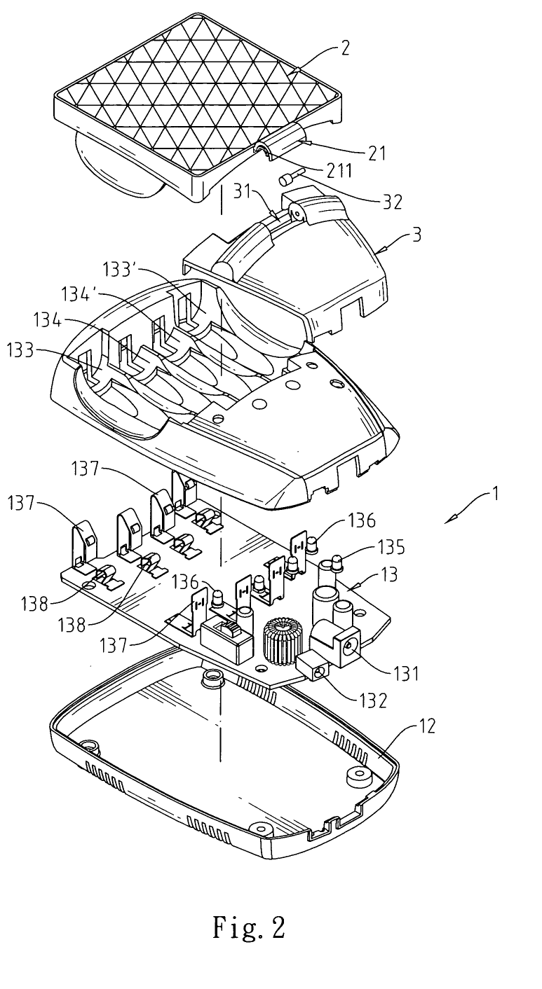

As shown in FIG. 2 and FIG. 3, the charging base 1 is composed of an upper shell 11 and a lower shell 12, which are coupled with each other. A circuit board 13 is mounted in a chamber formed between the assembled upper and lower shells 11, 12 for holding several devices including an input jack 131 for connection with an external power supply, an output jack 132 for supplying the electric power for an external electronic apparatus, several battery slots 133, 133′, 134, 134′, a power indicator light 135, and several status indicator lights 136. The battery slots 133, 133′ are electrically connected to the input jack 131 via the circuit board 13 to act as charging slots. The battery slots 134, 134′ are electrically connected to the output jack 132 via the circuit board 13 to act as power supply slots. The battery slots 133, 133′, 134, 134′ are suitable for two different types of rechargeable batteries simultaneously. As shown in FIG, 3, the AA-type rechargeable batteries 4 can be applied to the battery slots 133, 133′, 134, 134′ by using first elastic electrode plates 137 mounted on both ends of these battery slots, respectively. In addition, the AAA-type rechargeable batteries 4′ can be applied to the battery slots 133, 133′, 134, 134′ by using second elastic electrode plates 138 mounted in these battery slots between first elastic electrode plates 137, respectively, for forming the shorter battery slots. Besides, each of the battery slots 133, 133′, 134, 134′ is provided with a status indicator light 136 for showing the status of the rechargeable battery. The power indicator light 135 is designed for showing the “ON” or “OFF” status of the power source. The above-mentioned status indicator light 136 is a single light-emitting diode having different primary color chips for enabling the user to identify the usage status of the rechargeable batteries clearly and rapidly by means of different colored lights emitted from the light-emitting diode. For example, the red or orange light indicates that the rechargeable batteries are in charging process or short of electric power. Besides, the green light indicates that the charging process is completed or the rechargeable batteries are in discharging process.

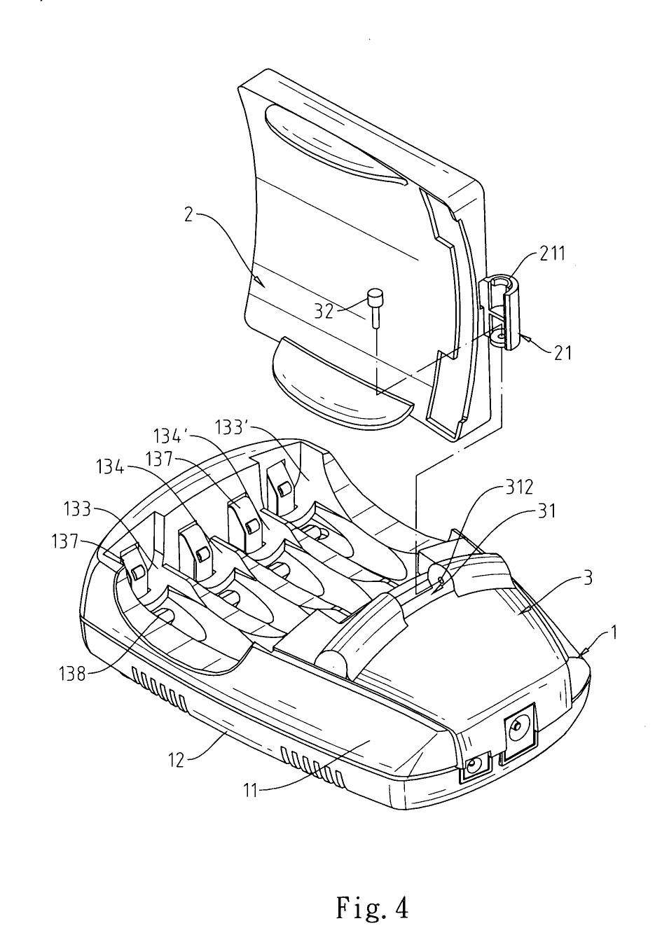

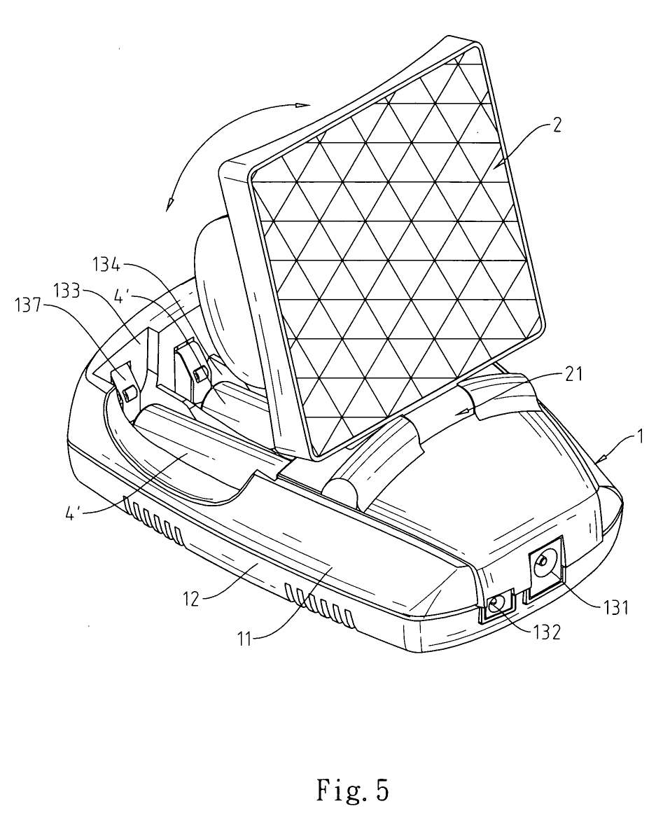

Referring to FIG. 3 through FIG. 5, the solar panel 2 is attached to the charging base 1 above the battery slots 133, 133′, 134, 134′ via a cover 3, wherein the cover 3 is made of a transparent material. When the cover 3 is fixed on the charging base 1, a pivotal rotation device 21 is connectedly mounted between the solar panel 2 and the cover 3 such that the solar panel 2 can be lifted up or folded down to various angles for adjusting the light-receiving angle of the solar panel 2, as shown in FIG. 5. The pivotal rotation device 21, which is in a semi-arc shape, is located to hook an edge notch 31 of the cover 3 such that an extended protrudent part 211 of the pivotal rotation device 21 is inserted into an axial hole 311 formed on one end of the cover 3, as shown in FIG. 3 and FIG. 4. In addition, an insertion pillar 32 is inserted into an insertion hole 312 formed on the other end of the cover 3 for the purpose of secure connection, as shown in FIG. 4.

Referring to FIG. 5 again, a schematic view of the lifting status of the solar panel of the preferred embodiment is shown. The solar panel 2 is integrally attached to the top of the charging base 1 to avoid the inconvenience to carry an external the solar panel and to help the receiving of solar light, thereby transforming the solar power into the electric power. Besides, the battery slots 133, 133′, 134, 134′ can be covered or uncovered by using the pivotal rotation device 21.

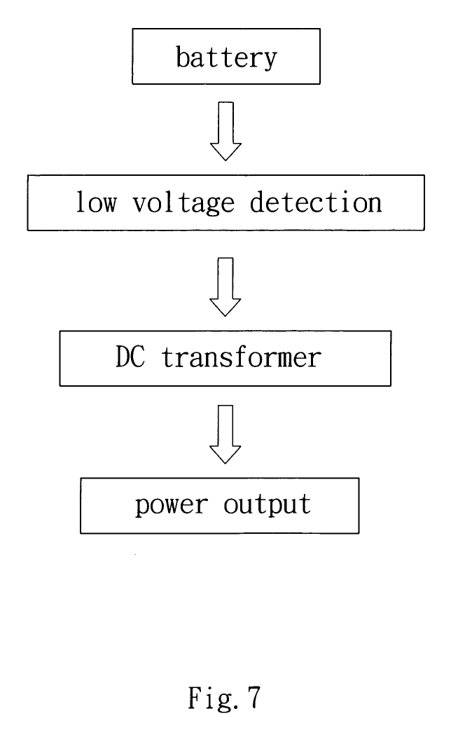

Referring to FIG. 3 and FIG. 7, if there is a need to charge the rechargeable batteries, the solar panel 2 can be utilized to supply the electric power or an external power supply 5 can be also utilized to charge the rechargeable batteries 4, 4′ located in the battery slots 133, 133′, wherein the power supply 5 is, for example, an AC-DC transformer 51 or a car-use power adapter 52. The charged rechargeable batteries 4, 4′ are then moved to the battery slots 134, 134′ for outputting the electric power of the rechargeable batteries 4, 4′ to the output jack 132 via a DC-DC booster circuit (shown in FIG. 7) for use in an external electronic apparatus 6 such a mobile phone.

It is worthy to additionally indicate that the power sources mounted in the battery slots 134, 134′ for supplying the external electronic apparatus 6 are, for example, the rechargeable batteries 4, 4′, but not limited thereto. In other words, other batteries such as Ni—H batteries or alkaline batteries can be applied to supply the electric power for the electronic product such as mobile phone or PDA via the output jack 132.

What the invention claimed is:

1. A battery charger comprising:
a charging base having an output jacket, an input jacket, and a plurality of battery slots; and
a solar panel attached to the charging base above the battery slots via a cover, wherein a pivotal rotation device is connectedly mounted between the solar panel and the cover such that the solar panel can be lifted up or folded down to various angles.

2. The battery charger of claim 1, wherein the cover is made of a transparent material.

3. The battery charger of claim 1, wherein first elastic electrode plates are mounted on both ends of the battery slots, respectively, and second elastic electrode plates are mounted between the first elastic electrode plates, respectively, for forming shorter battery slots.

4. The battery charger of claim 1, wherein two of the battery slots are electrically connected to the input jack to act as charging slots.

5. The battery charger of claim 1, wherein two of the battery slots are electrically connected to the input jack to act as power supply slots.
